(19) United States
(12) Patent Application Publication
(10) Pub. No.: US 2025/0070630 A1
(43) Pub. Date: Feb. 27, 2025

(54) ROTOR OF ROTARY ELECTRIC MACHINE COMPRISING CONDUCTORS OF FREE CROSS SECTION

(71) Applicant: SAFRAN VENTILATION SYSTEMS, Blagnac (FR)

(72) Inventors: Claude Pendaries, Moissy-Cramayel (FR); Xavier Longere, Moissy-Cramayel (FR); Jacques Vincent, Moissy-Cramayel (FR); Samuel Bonnard, Moissy-Cramayel (FR)

(73) Assignee: SAFRAN VENTILATION SYSTEMS, Blagnac (FR)

(21) Appl. No.: 18/726,741

(22) PCT Filed: Jan. 19, 2023
(86) PCT No.: PCT/FR2023/050075

§ 371 Date: Jul. 3, 2024

(30) Foreign Application Priority Data
Jan. 19, 2022 (FR) FR2200435

(51) Int. Cl. H02K 17/16; B64D 33/08

(52) U.S. Cl. CPC H02K 17/168; B64D 33/08

(57) ABSTRACT

Rotor of a rotary electric machine, comprising a body having two opposite lateral surfaces and a surface of revolution, two short-circuiting rings disposed in contact with each lateral surface of the body, and conductors disposed in slots formed on the surface of revolution of the body and each connected to the short-circuiting rings, characterised in that each conductor comprises at least one shoulder aligned with a lateral surface of the body.

### TECHNICAL FIELD

The technical field of the invention is that of rotary electric machines and more specifically assembling the components of a rotor of such a machine.

### PRIOR ART

A rotary electric machine comprises a stator and a rotor fitted with a body, in which conductor bars are arranged which are connected at their ends to short-circuiting rings.

In the prior art, document FR 3088152 describes a rotary electric machine and a corresponding manufacturing method, and document FR3029895 describes an aircraft fan, using a rotary electric machine.

In the manufacture of a rotor, a mechanical and electrical connection is expected between parts of the assembly of bars and short-circuiting rings.

In the prior art, short-circuiting rings are provided with holes for mounting conductor bars. The easiest holes to use in short-circuiting rings are conventionally circular.

In order to facilitate manufacturing, the conductor bars have the same cross-section along their entire length, usually a circular cross-section.

The assembly of rotors comprising such conductor bars and such short-circuiting rings exposes the quality of the connection between the bars and the short-circuiting rings to defects. Indeed, when conductor bars and short-circuiting rings are assembled, material can migrate between the conductor bars and the body of the rotor. Such migration can disturb the magnetic flux in the rotor. In the specific case of a soldered assembly, the solder migrates along the bars.

Using bars with non-circular cross-sections (squared, or any other shape) exacerbates the problems of the quality of connection between the bars and short-circuiting rings described above.

To avoid compounding the connection problems, it is very complex to adapt the holes in the short-circuiting rings to the shape of the conductor bars. This involves drilling holes with non-circular cross-sections.

The problems of the quality of connection between the bars and short-circuiting rings has a direct impact on the performance of the rotary electric machine.

The object of the invention is to solve these problems, in particular control material migration during assembly and make it possible to use conductor bars with non-circular cross-sections whilst avoiding compounding material migration problems and keeping costs down.

### DISCLOSURE OF THE INVENTION

One object of the invention is a rotor of a rotary electric machine, comprising a body having two opposite lateral surfaces and a surface of revolution, two short-circuiting rings disposed in contact with each lateral surface of the body, and conductors disposed in slots formed on the surface of revolution of the body and each connected to the short-circuiting rings. Each conductor comprises at least one shoulder aligned with a lateral surface of the body.

A conductor comprises a core part having a first square cross-section and at least one end part having a second circular cross-section, the core part and the at least one end part being separated by a shoulder, the first cross-section corresponding to the cross-section of the core part having a greater surface area than the second cross-section corresponding to the cross-section of the at least one end part.

The cross-section of the slots on the body can correspond to the first cross-section.

The conductor can be connected to one of the short-circuiting rings by soldering, shrinking, press-fitting or welding.

Another object of the invention is an electric machine comprising a rotor as described above.

Another object of the invention is an aircraft fan fitted with a rotary electric motor or a rotor as described above.

### BRIEF DESCRIPTION OF THE DRAWINGS

Other aims, features and advantages of the invention will appear upon reading the following description, given solely as a non-limiting example, and made with reference to the appended drawings wherein:

FIG. 1 shows an electric machine rotor according to the invention,

FIG. 2 shows a conductor of a rotor according to a first embodiment,

FIG. 3 shows a sectional view of a conductor after soldering into a short-circuiting ring, and

FIG. 4 shows a conductor of a rotor according to a second embodiment.

### DETAILED DESCRIPTION

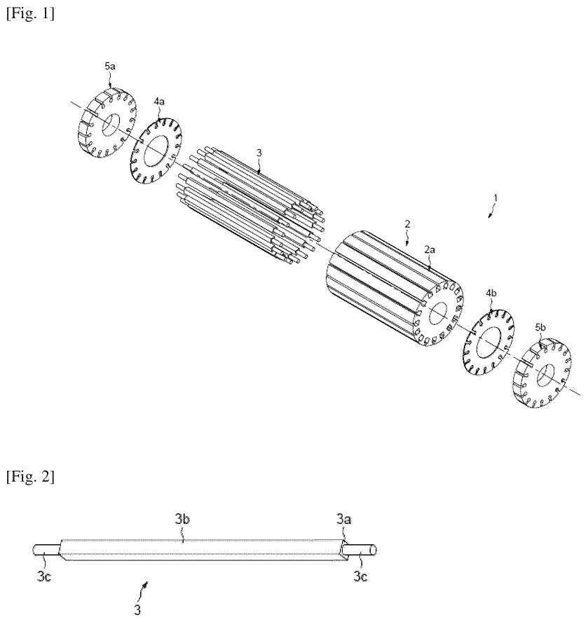

The rotor of a rotary electric machine according to the invention, shown in FIG. 1, comprises a body 2, a plurality of conductors 3 connected to the conductive flanges 4a, 4b and short-circuiting rings 5a, 5b.

The body 2 has a cylindrical shape formed by two lateral surfaces and a surface of revolution extending between the two lateral surfaces. The body 2 has a plurality of slots 2a spread over its lateral surface, in each of which a conductor 3 is arranged.

The rotor 1 of the rotary electric machine is unique in that it has conductors 3 having a shoulder 3a arranged between a core part 3b and end parts 3c, as shown in FIG. 2.

The shoulder 3a allows the use of conductors 3 with a cross-section of the core part 3b different from a circular cross-section in order to increase the density of power flowing in each conductor, while maintaining the ease of construction and assembly of end parts with a circular cross-section. Such conductors 3 with a cross-section of the core part 3b different from a circular cross-section enable the magnetic flow in the rotor to be optimised. It should be noted that the slots 2a have the same cross-section as the core part 3b of the conductors.

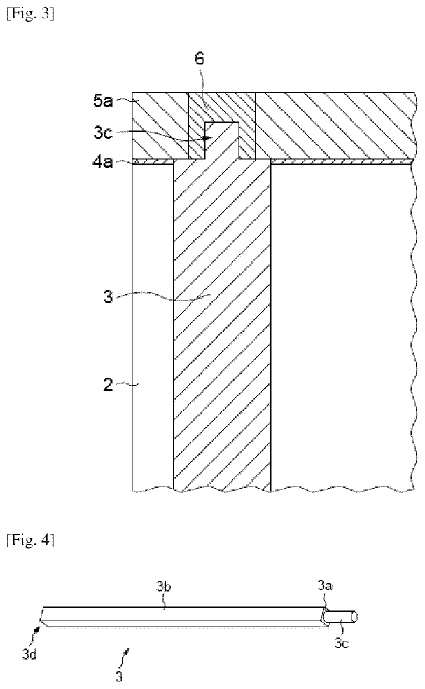

The shoulder 3a also has the function of preventing material infiltration (solder for example) between the conductors 3 and the body 2 at the slots 2a, in particular when the short-circuiting rings 5a, 5b are soldered to the conductors 3. FIG. 3 is a sectional view of an end part 3c of a conductor 3 after soldering into a short-circuiting ring 5a. The soldering area 6 extends as far as the shoulder 3a of the conductor bar 3 and does not extend between the body 2 and the conductor 3. It should be noted that the conductive flange 4a comprises a hole with the same shape and size as the slot 2a and the core part 3b of the conductor bar such that the shoulder 3a of the conductor bar 3 is in contact with the short-circuiting ring 5a. Such protection can also be applied to other assembly methods, in particular shrinking and welding. It should also be noted that FIG. 3 has been shown considering an end part 3c arranged in a short-circuiting ring 5a and a conductive flange 4a. The same would apply if we were to consider another short-circuiting ring 5b and another conductive flange 4b.

The end parts 3c of the conductors have circular cross-sections, making them easier to produce, to make the corresponding openings in the short-circuiting rings 5a, 5b, and to assemble. However, other sectional shapes can be envisaged, such as triangular, prismatic or ovoid.

Although the rotor 1 according to the invention is described above as being assembled by soldering, other assembly methods can be envisaged, such as shrinking, press-fitting or welding.

In one embodiment, the conductors 3 are made of copper (A1). Other materials can be considered.

In one specific embodiment, the core part 3b of the conductor has a single shoulder 3a and a single end part 3c. The end 3d of the core part 3b directly opposite the end part 3c is therefore connected to a short-circuiting ring 5. FIG. 4 shows such an embodiment.

1. Rotor of a rotary electric machine, comprising a body having two opposite lateral surfaces and a surface of revolution, two short-circuiting rings disposed in contact with each lateral surface of the body, and conductors disposed in slots formed on the surface of revolution of the body and each connected to the short-circuiting rings, wherein each conductor comprises at least one shoulder aligned with a lateral surface of the body, a conductor comprises a core part having a first square cross-section and at least one end part having a second circular cross-section, the core part and the at least one end part are separated by a shoulder, and the first cross-section corresponding to the cross-section of the core part having a greater surface area than the second cross-section corresponding to the cross-section of the at least one end part.

2. Rotor according to claim 1, wherein the cross-section of the slots on the body corresponds to the first cross-section.

3. Rotor according to claim 1, wherein the conductor is connected to at least one of the short-circuiting rings by soldering, shrinking, press-fitting or welding.

4. Electric machine comprising a rotor according to claim 1.

5. Aircraft fan, comprising an electric machine according to claim 4.

6. Aircraft fan, comprising a rotor according to claim 1.
